(19) United States
(12) Patent Application Publication
(10) Pub. No.: US 2014/0027011 A1
(43) Pub. Date: Jan. 30, 2014

(54) System and Method for Combining, Packaging, and Separating Blended Seed Product

(71) Applicants: John R. Bahr, Grimes, IA (US); Christopher Baszczynski, Earlham, IA (US); William A. Belzer, Grimes, IA (US); Thomas R. Bockhaus, Urbandale, IA (US); Paula Marie Davis, Grimes, IA (US); Terry L. Garner, Waukee, IA (US); Laura S. Higgins, Des Moines, IA (US); Gary S. Nehmer, Des Moines, IA (US); Gerald A. Vlach, Johnston, IA (US)

(72) Inventors: John R. Bahr, Grimes, IA (US); Christopher Baszczynski, Earlham, IA (US); William A. Belzer, Grimes, IA (US); Thomas R. Bockhaus, Urbandale, IA (US); Paula Marie Davis, Grimes, IA (US); Terry L. Garner, Waukee, IA (US); Laura S. Higgins, Des Moines, IA (US); Gary S. Nehmer, Des Moines, IA (US); Gerald A. Vlach, Johnston, IA (US)

(73) Assignee: PIONEER HI BRED INTERNATIONAL INC, Johnston, IA (US)

(21) Appl. No.: 13/991,959

(22) PCT Filed: Dec. 6, 2011
(86) PCT No.: PCT/US11/63396

§ 371 Date: Sep. 27, 2013

Related U.S. Application Data
(60) Provisional application No. 61/420,095, filed on Dec. 6, 2010.

(51) Int. Cl. A01C 1/00; B07C 5/00; B01F 5/00

(52) U.S. Cl. CPC A01C 1/00; B01F 5/00; B07C 5/00
USPC 141/9; 209/552; 209/592

(57) ABSTRACT

A system and method are provided for creating a precision blended seed product. A first seed group is received in a first seed hopper and transferred to a first automated metering device. A second seed group is received in a second seed hopper and transferred to a second automated metering device. A controlled portion of seed may then be metered from the first seed group with the first automated metering device and from the second seed group with the second automated metering device. The respective metered portions can then be combined together to create a precision blended seed product that includes a predetermined portion of the first seed group and a predetermined portion of the second seed group. In addition, a system and method are provided for separating two or more seed groups from a blended seed product, for example, to test one or both components and replace bad seed.

### FIELD OF THE INVENTION

The present invention relates generally to systems and methods for creating a precision blended seed product. More specifically, the present invention provides a system and method for combining seeds with different genetic traits or to which different treatments may have been applied to create a precision blended seed product that includes a predetermined portion of each different seed group. The present invention also provides a system and method for separating seeds that have previously been blended.

### BACKGROUND OF THE INVENTION

One of the biggest problems that farmers face around the world is the destruction of their crops by pests. The use of pesticides to kill such pests, while effective, is viewed by some as harmful to more than just the targeted pests, as the chemicals used in the pesticides may remain on or leach into the crop and reach the end consumer, or the chemicals may make their way into the water table, again potentially damaging the environment.

Another problem agriculturists face is the encroachment of non-crop vegetation into an area designated for growing crops. “Weeds” and other unwanted vegetation may weaken or kill the desirable crops by depleting the nutrients in the soils and/or consuming the water supply intended for the crops. Again, chemicals in the form of herbicides may be used to kill targeted vegetation; however, in some cases, the herbicides may have the unintended effect of also harming or impeding the growth of the crop itself.

In response, scientists have developed transgenic seed, which is seed that has been genetically engineered to have agronomically desirable traits, such as resistance to pests or herbicides. For example, one type of genetically modified corn known as “Bt corn” expresses a gene from the soil bacterium Bacillus thuringiensis. The Bt protein causes the formation of pores in the digestive tract of certain types of insects. Thus, when the insect ingests Bt corn, the insect typically develops these pores, which disrupt the insect's midgut, causes cessation in feeding, and makes the insect susceptible to life threatening bacterial infections.

By law, farmers in the United States who plant Bt corn are required to plant “refuge” corn (such as, but not limited to, non-Bt corn) in the vicinity. The idea of creating a refuge plot is to slow the evolution of pests that may be naturally resistant to the Bt toxin. In other words, by providing refuge corn for the pests to consume, some believe that the natural evolutionary process of selecting Bt-resistant pests for survival is slowed down.

As a result, there is a need for providing a system and method for facilitating compliance of farmers growing genetically modified crops with the federal regulations mandating the creation of refuge plots. In various embodiments, the system and method should allow farmers to have the mandated proportion of refuge crop regardless of the acreage of the farmer's land with minimal effort and expense by the farmer.

### BRIEF SUMMARY OF VARIOUS EMBODIMENTS

The present invention addresses the above needs and achieves other advantages by providing a method of creating a precision blended seed product. In general, the method comprises receiving a first seed group in a first seed hopper, receiving a second seed group in a second seed hopper, transferring the first seed group from the first seed hopper to a first automated metering device, transferring the second seed group from the second seed hopper to a second automated metering device, metering a controlled portion of seed from the first seed group with the first automated metering device, metering a controlled portion of seed from the second seed group with the second automated metering device, and combining the respective metered portions together in a package to create a precision blended seed product that includes a predetermined portion of the first seed group and a predetermined portion of the second seed group. In some embodiments, the first seed group comprises seed of a transgenic pest-resistant crop and the second seed group comprises seed of a non-transgenic crop. In some embodiments, the first seed group comprises seed of a transgenic pest-resistant crop and the second seed group comprises seed of a transgenic herbicide tolerant crop. In some embodiments, the first seed group comprises seed of a non-transgenic crop and the second seed group comprises seed of a non-transgenic crop. In some embodiments, the first seed group comprises seed of a first transgenic pest-resistant crop and the second seed group comprises seed of a second transgenic pest-resistant crop. In some embodiments, the predetermined portions of the precision blended seed product comprise approximately 80% seed from the first seed group and approximately 20% seed from the second seed group. In some embodiments, the predetermined portions of the precision blended seed product comprise approximately 90% seed from the first seed group and approximately 10% seed from the second seed group. In some embodiments, the predetermined portions of the precision blended seed product comprise approximately 95% seed from the first seed group and approximately 5% seed from the second seed group.

In some embodiments, the first seed group comprises seed treated with a first seed treatment and the second seed group comprises seed treated with a second seed treatment. In some embodiments, the first and second seed treatments are selected from the group consisting of: insecticides; fungicides; nematicides; growth regulators; colorants; amendments; micronutrients; inoculants; carriers; coatings; polymers; and combinations thereof. In some embodiments, the first seed group comprises seed of a transgenic male-sterile parent crop and the second seed group comprises seed of a transgenic pollinator crop. In some embodiments, the predetermined portions of the precision blended seed product comprise between approximately 80% and approximately 95% seed from the first seed group and between approximately 20% and approximately 5% seed from the second seed group. In some embodiments, the predetermined portions of the precision blended seed product comprise approximately 91% seed from the first seed group and approximately 9% seed from the second seed group.

In some embodiments, the seed from the first and second seed groups is selected from the group consisting of: corn seed; cotton seed; sunflower seed; grass seed; millet seed; vegetable seed; flower seed; soybean seed; alfalfa seed; wheat seed; sorghum seed; canola seed; and rice seed. In some embodiments, the step of metering a controlled portion of seed from the first seed group comprises metering a controlled portion of seed from the first seed group using a first precision weigh belt feeder, and wherein the step of metering a controlled portion of seed from the second seed group comprises metering a controlled portion of seed from the second seed group using a second precision weigh belt feeder. In some embodiments, the step of metering a controlled portion of seed from the first seed group comprises metering a controlled portion of seed from the first seed group using at least one of a first vibratory feeder and a gravity feeder, and wherein the step of metering a controlled portion of seed from the second seed group comprises metering a controlled portion of seed from the second seed group using a second vibratory feeder and a weighing hopper. In some embodiments, the controlled portion of seed from the first seed group and the controlled portion of seed from the second seed group are received together in a third seed hopper.

In some embodiments, the predetermined portions of the precision blended seed product comprise approximately 80% seed from the first seed group and approximately 20% seed from the second seed group. In some embodiments, the predetermined portions of the precision blended seed product comprise approximately 90% seed from the first seed group and approximately 10% seed from the second seed group. In some embodiments, the predetermined portions of the precision blended seed product comprise approximately 95% seed from the first seed group and approximately 5% seed from the second seed group. In some embodiments, the predetermined portions of the precision blended seed product comprise approximately 90% seed from the first seed group and approximately 10% seed from the second seed group.

The present invention also provides a method of separating two or more seed groups from a blended seed product. In general, the method comprises receiving at an automated seed separating device a blended seed product containing a blend comprising seed from a first seed group and seed from a second seed group, and separating the blended seed product using the automated seed separating device into a portion of seed that substantially consists of seed from the first seed group and a portion of seed that substantially consists of seed from the second seed group. In some embodiments, the seed separating device is configured to separate seed based on a seed characteristic selected from the group consisting of: seed size, seed color, seed treatment color, seed density, seed shape, and seed weight. In some embodiments, the step of separating the blended seed product comprises separating the blended seed product using an automated precision color seed sorter.

In some embodiments, the first seed group comprises seed of a transgenic pest-resistant crop and the second seed group comprises seed of a non-transgenic crop. In some embodiments, the first seed group comprises seed of a transgenic pest-resistant crop and the second seed group comprises seed of a transgenic herbicide tolerant crop. In some embodiments, the first seed group comprises seed of a non-transgenic crop and the second seed group comprises seed of a non-transgenic crop. In some embodiments, the first seed group comprises seed of a first transgenic pest-resistant crop and the second seed group comprises seed of a second transgenic pest-resistant crop. In some embodiments, the first seed group comprises a portion of seed treated with a first seed treatment and the second seed group comprises a portion of seed treated with a second seed treatment. In some embodiments, the first seed group comprises seed of a transgenic male-sterile parent crop and the second seed group comprises seed of a transgenic pollinator crop.

Some embodiments further comprise determining a relative ratio of the first and second seed groups in the blended seed product based on the separating step. Some embodiments further comprise testing viability of the separated seed from the first seed group or the separated seed from the second seed group. Some embodiments further comprise discarding at least a portion of one of the separated seed from the first seed group or the separated seed from the second seed group based on said testing step. Some embodiments further comprise combining a metered portion of the undiscarded one of the separated seed from the first seed group or the separated seed from the second seed group with a metered portion of new seed of the other of the first seed group or the second seed group to create a precision blended seed product that includes a predetermined portion of the first seed group and a predetermined portion of the second seed group.

### BRIEF DESCRIPTION OF THE DRAWINGS

Having thus described the invention in general terms, reference will now be made to the accompanying drawings, which are not necessarily drawn to scale, and wherein:

FIG. 1A illustrates a field with a structured refuge;

FIG. 1B illustrates a field where the refuge crop is integrated with the non-refuge crop in accordance with an exemplary embodiment of the present invention;

FIG. 2 shows a schematic illustration of a system for creating a precision blended seed product in accordance with an exemplary embodiment of the present invention;

FIG. 3 shows a schematic illustration of the control system of FIG. 2 in accordance with an exemplary embodiment of the present invention;

FIG. 4 shows a schematic illustration of the user interface of FIG. 3 in accordance with an exemplary embodiment of the present invention;

FIG. 5 illustrates a method of creating a precision blended seed product in accordance with an exemplary embodiment of the present invention;

FIG. 6 shows a schematic illustration of a system for separating two or more seed groups from a blended seed product in accordance with an exemplary embodiment of the present invention; and

FIG. 7 illustrates a method of separating two or more seed groups from a blended seed product in accordance with an exemplary embodiment of the present invention.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

As will be described below, the present invention is generally directed to a system and method for combining seeds with different genetic traits or to which different treatments may have been applied to create a precision blended seed product that includes a predetermined portion of each different seed group. The present invention also provides a system and method for separating seeds that have previously been blended

In the description that follows, a number of terms are used extensively. The following definitions are provided to facilitate understanding of the invention.

A “plot” is intended to mean an area where crops are planted of whatever size. As used herein, the term “transgenic pest-resistant” crop and/or plant means a plant or progeny thereof (including seeds) derived from a transformed plant cell or protoplast, wherein the plant DNA contains an introduced heterologous DNA molecule, not originally present in a native, non-transgenic plant of the same strain, that confers resistance to one or more pests, such as corn rootworms. As used herein, the term “transgenic herbicide tolerant” crop and/or plant means a plant or progeny thereof (including seeds) derived from a transformed plant cell or protoplast, wherein the plant DNA contains an introduced heterologous DNA molecule, not originally present in a native, non-transgenic plant of the same strain, that confers tolerance to one or more herbicides. The term refers to the original transformant and progeny of the transformant that include the heterologous DNA. The term also refers to progeny produced by a sexual outcross between the transformant and another variety that includes the heterologous DNA. It is to be understood that two different transgenic plants can also be mated to produce offspring that contain two or more independently segregating, added, heterologous genes. Selfing of appropriate progeny can produce plants that are homozygous for both added, heterologous genes. Back-crossing to a parental plant and out-crossing with a non-transgenic plant are also contemplated, as is vegetative propagation. Descriptions of other breeding methods that are commonly used for different traits and crop plants can be found in one of several references, e.g., Fehr (1987), in Breeding Methods for Cultivar Development, ed. J. Wilcox (American Society of Agronomy, Madison, Wisc.). Breeding methods can also be used to transfer any natural resistance genes into crop plants.

As used herein, the term “corn” means Zea mays or maize and includes all plant varieties that can be bred with corn, including wild maize species. In one embodiment, the disclosed systems and methods are useful for managing resistance in a plot of pest resistant corn, where corn is systematically followed by corn (i.e., continuous corn). In another embodiment, the methods are useful for managing resistance in a plot of first-year pest resistant corn, that is, where corn is followed by another crop (e.g., soybeans), in a two-year rotation cycle. Other rotation cycles are also contemplated in the context of the invention, for example where corn is followed by multiple years of one or more other crops, so as to prevent resistance in other extended diapause pests that may develop over time.

A crop is considered to have a “high dose” of a pesticidal agent if it has or produces at least about 25 times the concentration of pesticidal agent (such as, for example, Bt protein) necessary to kill susceptible larvae. For example, in the context of high dose Bt crops, Bt cultivars must produce a high enough toxin concentration to kill all susceptible insects and nearly all of the insects that are heterozygous for resistance, assuming, of course, that a single gene can confer resistance to the particular Bt protein or other toxin. Currently, a Bt plant-incorporated protectant is generally considered to provide a high dose if verified by at least two of the following five approaches: 1) Serial dilution bioassay with artificial diet containing lyophilized tissues of Bt plants using tissues from non-Bt plants as controls; 2) Bioassays using plant lines with expression levels approximately 25-fold lower than the commercial cultivar determined by quantitative ELISA or some more reliable technique; 3) Survey of large numbers of commercial plants in the field to make sure that the cultivar is at the LD_{99.9} or higher to assure that 95% of heterozygotes would be killed (see Andow & Hutchison 1998); 4) Similar to #3 above, but would use controlled infestation with a laboratory strain of the pest that had an LD₅₀ value similar to field strains; and 5) Determine if a later larval instar of the targeted pest could be found with an LD₅₀ that was about 25-fold higher than that of the neonate larvae. If so, the later stage could be tested on the Bt crop plants (or plant tissue) to determine if 95% or more of the later stage larvae were killed.

As used herein, the term “polypeptide,” “peptide,” and “protein” are used interchangeably herein to refer to a polymer of amino acid residues. The terms apply to amino acid polymers in which one or more amino acid residues is an artificial chemical analogue of a corresponding naturally-occurring amino acid, as well as to naturally-occurring amino acid polymers.

As used herein, the terms “pesticidal activity” and “insecticidal activity” are used synonymously to refer to activity of an organism or a substance (such as, for example, a protein) that can be measured, by way of non-limiting example, via pest mortality, retardation of pest development, pest weight loss, pest repellency, and other behavioral and physical changes of a pest after feeding and exposure for an appropriate length of time. In this manner, pesticidal activity often impacts at least one measurable biological parameter of the pest life cycle. For example, the pesticide may be a polypeptide to decrease or inhibit insect feeding and/or to increase insect mortality upon ingestion of the polypeptide. Assays for assessing pesticidal activity are well known in the art. See, e.g., U.S. Pat. Nos. 6,570,005 and 6,339,144.

As used herein, the term “pesticidal gene” or “pesticidal polynucleotide” refers to a nucleotide sequence that encodes a polypeptide that exhibits pesticidal activity. As used herein, the terms “pesticidal polypeptide,” “pesticidal protein,” or “insect toxin” is intended to mean a protein having pesticidal activity.

As used herein, the term “pesticidal” is used to refer to a toxic effect against a pest (e.g., CRW), and includes activity of either, or both, an externally supplied pesticide and/or an agent that is produced by the crop plants. As used herein, the phrase “different mode of pesticidal action” includes the pesticidal effects of one or more resistance traits, whether introduced into the crop plants by transformation or traditional breeding methods, such as binding of a pesticidal toxin produced by the crop plants to different binding sites (i.e., different toxin receptors and/or different sites on the same toxin receptor) in the gut membranes of corn rootworms. With regard to modes of pesticidal action, pesticidal compounds bind “competitively” if they share identical binding sites in the pest with no binding sites that one compound will bind that the other will not bind. For example, if compound A uses binding sites 1 and 2 only, and compound B also uses binding sites 1 and 2 only, compounds A and B bind “competitively.” Pesticidal compounds bind “semi-competitively” if they share at least one common binding site in the pest, but also at least one binding site not in common. For example, if compound C uses binding sites 3 and 4, and compound D uses only binding site 3, compounds C and D bind “semi-competitively.” Pesticidal compounds bind “non-competitively” if they share no binding sites in common in the pest. For example, if compound E uses binding sites 5 and 6, and compound F uses binding site 7, compounds E and F bind “non-competitively.”

As used herein, the term “pesticidally effective amount” connotes a quantity of a substance or organism that has pesticidal activity when present in the environment of a pest. For each substance or organism, the pesticidally effective amount is determined empirically for each pest affected in a specific environment. Similarly an “insecticidally effective amount” may be used to refer to a “pesticidally effective amount” when the pest is an insect pest.

As used herein, the term “transgenic” includes any cell, cell line, callus, tissue, plant part, or plant, the genotype of which has been altered by the presence of heterologous nucleic acid including those transgenics initially so altered as well as those created by sexual crosses or asexual propagation from the initial transgenic. The term “transgenic” as used herein does not encompass the alteration of the genome (chromosomal or extra-chromosomal) by conventional plant breeding methods or by naturally occurring events such as random cross-fertilization, non-recombinant viral infection, non-recombinant bacterial transformation, non-recombinant transposition, or spontaneous mutation.

As used herein, the term “plant” includes reference to whole plants, plant organs (e.g., leaves, stems, roots, etc.), seeds, plant cells, plant protoplasts, plant cell tissue cultures from which plants can be regenerated, plant calli, plant clumps, and plant cells that are intact in plants or parts of plants and progeny of same. Parts of transgenic plants are to be understood within the scope of the invention to comprise, for example, plant cells, protoplasts, tissues, callus, and embryos as well as flowers, pollen, ovules, seeds, branches, kernels, ears, cobs, husks, stalks, stems, fruits, leaves, roots, root tips, anthers, and the like, originating in transgenic plants or their progeny previously transformed with a DNA molecule of the invention and therefore consisting at least in part of transgenic cells, are also an object of the present invention. Grain is intended to mean the mature seed produced by commercial growers for purposes other than growing or reproducing the species. Progeny, variants, and mutants of the regenerated plants are also included within the scope of the invention, provided that these parts comprise the introduced polynucleotides.

As used herein, the term “plant cell” includes, without limitation, seeds, suspension cultures, embryos, meristematic regions, callus tissue, leaves, roots, shoots, gametophytes, sporophytes, pollen, and microspores. The class of plants that can be used in the methods of the invention is generally as broad as the class of higher plants amenable to transformation techniques, including both monocotyledonous and dicotyledonous plants.

As used herein, the term “creating or enhancing insect resistance” is intended to mean that the plant, which has been genetically modified in accordance with the methods of the present invention, has increased resistance to one or more insect pests relative to a plant having a similar genetic component with the exception of the genetic modification described herein. “Protects a plant from an insect pest” is intended to mean the limiting or eliminating of insect pest-related damage to a plant by, for example, inhibiting the ability of the insect pest to grow, feed, and/or reproduce or by killing the insect pest. As used herein, “impacting an insect pest of a plant” includes, but is not limited to, deterring the insect pest from feeding further on the plant, harming the insect pest by, for example, inhibiting the ability of the insect to grow, feed, and/or reproduce, or killing the insect pest.

As used herein, “blending” seeds means, for example, blending at least two (i.e., two or more) types of seeds in a bag (such as during packaging, production, or sale), blending at least two types of seeds in a plot, or any other method that results in at least two types of seeds being introduced into plot. The blend could result in a random arrangement in the plot, or could be in the context of a structured refuge of some type (such as, for example, a block refuge or strip refuge). When a structured refuge is used, a “plot” as used herein may, but does not necessarily, include such structured refuge.

Those skilled in the art will recognize that not all compounds are equally effective against all pests. Compounds of the embodiments display activity against insect pests, which may include economically important agronomic, forest, greenhouse, nursery, ornamentals, food and fiber, public and animal health, domestic and commercial structure, household, and stored product pests. Insect pests include insects selected from the orders Coleoptera, Diptera, Hymenoptera, Lepidoptera, Mallophaga, Homoptera, Hemiptera, Orthoptera, Thysanoptera, Dermaptera, Isoptera, Anoplura, Siphonaptera, Trichoptera, etc., particularly Coleoptera and Lepidoptera. Further details regarding insect pests may be found in U.S. Patent Publication No. 2010/0029725 entitled Resistance Management Strategies, the contents of which are incorporated by reference herein.

### Description of Pesticidal Action

Exemplary embodiments of the invention comprise systems and methods for preparing precision blends of seed product having predetermined degrees of pesticidal effectiveness or configured to provide pesticidal action in different ways. In some embodiments, for example, different modes of pesticidal action are used to avoid development of resistance in, for example, corn rootworms. Resistance to rootworms can be introduced into the crop plant by any method known in the art. In some embodiments, the different modes of pesticidal action include toxin binding to different binding sites in the gut membranes of the corn rootworms. Transgenes (such as those described in U.S. Patent Publication No. 2010/0029725, referenced above) useful against rootworms include, but are not limited to, those encoding Bt proteins. Other transgenes appropriate for other pests are also known in the art.

In some embodiments of the invention, a controlled portion of seed from a first seed group is combined with a controlled portion of seed from a second seed group to create a precision blended seed product that includes a predetermined portion of the first seed group and a predetermined portion of the second seed group. The first seed group, for example, may include seeds that include a pesticidal gene to provide the plant with resistance. A non-limiting example of such a gene is a gene that encodes a Bt toxin, such as a homologue of a known Crystal (“Cry” toxin. “Bt toxin” is intended to mean the broader class of toxins found in various strains of Bt, which includes such toxins as, for example, the vegetative insecticidal proteins and the δ-endotoxins. See, e.g., Crickmore et al. (1998) Microbiol. Molec. Biol. Rev. 62:807-813; Crickmore et al. (2004) Bacillus Thuringiensis Toxin Nomenclature at www.lifesci.sussex.ac.uk/Home/Neil_Crickmore/Bt. The vegetative insecticidal proteins (for example, members of the VIP1, VIP2, or VIP3 classes) are secreted insecticidal proteins that undergo proteolytic processing by midgut insect fluids. They have pesticidal activity against a broad spectrum of Lepidopteran insects. See, e.g., U.S. Pat. No. 5,877,012. The Bt δ-endotoxins are toxic to larvae of a number of insect pests, including members of the Lepidoptera, Diptera, and Coleoptera orders. These insect toxins include, but are not limited to, the Cry toxins, including, for example, Cry1, Cry3, Cry5, Cry8, and Cry9.

The seeds of the first seed group may in some cases have additional pesticidal traits. In certain embodiments, alternative pesticidal mode of action includes one or more insecticidal seed treatments either alone or in combination with one or more transgenic traits disclosed herein. In certain embodiment, the transgenic mode of action includes RNAi-based silencing of endogenous insect genes e.g., in corn root worm, stinkbugs, soybean cyst and plant viral diseases (see e.g., U.S. 20090192117, U.S. Pat. No. 7,812,219, and U.S. 20090265818). In certain embodiments, the plants of the first seed group produce more than one toxin, for example, via gene stacking. (Gene stacks refer to different transgenes in the same plants, whereas gene pyramids refer to multiple transgenes targeting the same organism.) For example, DNA constructs in the plants may comprise any combination of stacked nucleotide sequences of interest in order to create plants with a desired trait. In this regard, a “trait,” as used herein, refers to the phenotype derived from a particular sequence or groups of sequences. A single expression cassette may contain both a nucleotide encoding a pesticidal protein of interest and at least one additional gene, such as a gene employed to increase or improve a desired quality of the transgenic plant. Alternatively, the additional gene(s) can be provided on multiple expression cassettes. The combinations generated can also include multiple copies of any one of the polynucleotides of interest.

For example, gene stacks in the plants of the first seed group may contain one or more polynucleotides encoding polypeptides having pesticidal and/or insecticidal activity, such as Bt toxic proteins (described in, for example, U.S. Pat. Nos. 5,188,960; 5,277,905; 5,366,892; 5,593,881; 5,625,136; 5,689,052; 5,691,308; 5,723,756; 5,747,450; 5,859,336; 6,023,013; 6,114,608; 6,180,774; 6,218,188; 6,342,660; and 7,030,295; U.S. Publication Nos. U.S. 20040199939 and U.S. 20060085870; WO2004086868; and Geiser et al. (1986) Gene 48:109) and Bt crystal proteins of the Cry34 and Cry35 classes (see, e.g., Schnepf et al. (2005) Appl. Environ. Microbiol. 71:1765-1774). The gene stacks may also include vegetative insecticidal proteins (for example, members of the VIP1, VIP2, or VIP3 classes). See, e.g., U.S. Pat. Nos. 5,849,870; 5,877,012; 5,889,174; 5,990,383; 6,107,279; 6,137,033; 6,291,156; 6,429,360; U.S. Publication Nos. U.S. 200502 10545; U.S 20040 133942; U.S. 20020078473.

The Bt δ-endotoxins or Cry toxins that could be used in gene stacks are well known in the art. See, e.g., U.S. Publication No. US20030177528. These toxins include Cry 1 through Cry42, Cyt 1 and 2, Cyt-like toxin, and the binary Bt toxins. There are currently over 250 known species of Bt δ-endotoxins with a wide range of specificities and toxicities. For an expansive list see Crickmore et al. (1998) Microbiol. Ma Biol. Rev. 62:807-813, and for regular updates via the World Wide Web, see www.biols.susx.ac.uk/Home/Neil_Crickmore/Bt/index. The criteria for inclusion in this list is that the protein has significant sequence similarity to one or more toxins within the nomenclature or be a Bacillus thuringiensis parasporal inclusion protein that exhibits pesticidal activity, or that the protein has some experimentally verifiable toxic effect to a target organism. In the case of binary Bt toxins, those skilled in the art will recognize that two Bt toxins must be co-expressed to induce Bt insecticidal activity.

Specific, non-limiting examples of Bt Cry toxins of interest include the group consisting of Cry1 (such as Cry1A, Cry1A(a), Cry1A(b), Cry1A(c), Cry1C, Cry 1 D, Cry 1 E, Cry1F), Cry2 (such as Cry2A), Cry3 (such as Cry3Bb), CryS, Cry8 (see GenBankAccessionNos. CAD57542, CAD57543; see also U.S. Pat. No. 7,462,760), Cry9 (such as Cry9C) and Cry34/35, as well as functional fragments, chimeric or shuffled modifications, or other variants thereof.

Stacked genes in plants of the embodiments may also encode polypeptides having insecticidal activity other than Bt toxic proteins, such as lectins (Van Damme et al. (1994) Plant Mol. Biol. 24:825, pentin (described in U.S. Pat. No. 5,981,722), lipases (lipid acyl hydrolases, see, e.g., those disclosed in U.S. Pat. Nos. 6,657,046 and 5,743,477; see also WO2006131750A2), cholesterol oxidases from Streptomyces, and pesticidal proteins derived from Xenorhabdus and Photorhabdus bacteria species, Bacillus laterosporus species, and Bacillus sphaericus species, and the like. Also contemplated is the use of chimeric (hybrid) toxins (see, e.g., Bosch et al. (1994) Bio/Technology 12:915-918).

Such transformants can contain transgenes that are derived from the same class of toxin (e.g., more than one δ-endotoxin, more than one pesticidal lipase, more than one binary toxin, and the like), or the transgenes can be derived from different classes of toxins (e.g., a δ-endotoxin in combination with a pesticidal lipase or a binary toxin). For example, a plant having the ability to express an insecticidal δ-endotoxin derived from Bt (such as Cry1F) also has the ability to express at least one other δ-endotoxin that is different from the Cry1F protein, such as, for example, a Cry1A(b) protein. Similarly, a plant having the ability to express an insecticidal δ-endotoxin derived from Bt (such as Cry1F) also has the ability to express a pesticidal lipase, such as, for example, a lipid acyl hydrolase.

In practice, certain stacked combinations of the various Bt and other genes described previously are best suited for certain pests, based on the nature of the pesticidal action and the susceptibility of certain pests to certain toxins. For example, some transgenic combinations are particularly suited for use against various types of corn rootworm (CRW), including WCRW, northern corn rootworm (NCRW), and Mexican corn rootworm (MCRW). These combinations include at least Cry34/35 and Cry3A; and Cry34/35 and Cry3B. Other combinations are also known for other pests. For example, combinations appropriate for use against ECB and/or southwestern corn borer (SWCB) include at least Cry1Ab and Cry1F, Cry1Ab and Cry2, Cry1Ab and Cry9, Cry1Ab and Cry2/Vip3A stack, Cry1Ab and CrylF/Vip3A stack, Cry1F and Cry2, Cry1F and Cry9, as well as Cry1F and Cry2/Vip3A stack. Combinations appropriate for use against corn earworm (CEW) include at least Cry1Ab and Cry2, Cry1F and Cry2, Cry1Ab and Cry1F, Cry2 and Vip3A, Cry1Ab and Cry2/Vip3A stack, Cry1Ab and Cry1F/Vip3A stack, as well as Cry1F and Cry2/Vip3A stack. Combinations appropriate for use against fall armyworm (FAW) include at least Cry1F and Cry1Ab, Cry1F and Vip3A, Cry1Ab and Cry1F/Vip3A stack, Cry1F and Cry2/Vip3A stack, and CrylAb and Cry2/Vip3A stack. Combinations appropriate for use against black cutworm (BCW) and/or western bean cutworm (WBCW) include Cry1F and Vip3A, Cry1F and Cry2, as well as Cry1F and Cry2/Vip3A stack. Also, these various combinations may be further combined with each other in order to provide resistance management of multiple pests.

The plants of the embodiments can also contain gene stacks containing a combination of genes to produce plants with a variety of desired trait combinations including, but not limited to, traits desirable for animal feed such as high oil genes (e.g., U.S. Pat. No. 6,232,529); balanced amino acids (e.g., hordothionins (U.S. Pat. Nos. 5,990,389; 5,885, 801; 5,885,802; 5,703,049); barley high lysine (Williamson et al. (1987) Eur. J. Biochem. 165:99-106; WO 98/20122) and high methionine proteins (Pedersen et al. (1986) J. Biol. Chem. 261:6279; Kirihara et al. (1988) Gene 71:359; Musumura et al. (1989) Plant Mol. Biol. 12:123))); and increased digestibility (e.g., modified storage proteins (U.S. Pat. No. 6,858,778) and thioredoxins (U.S. Pat. No. 7,009,087)).

The plants of the embodiments can also contain gene stacks that comprise genes resulting in traits desirable for disease resistance (e.g., fumonisin detoxification genes (U.S. Pat. No. 5,792,931) and avirulence and disease resistance genes (Jones et al. (1994) Science 266:789; Martin et al. (1993) Science 262:1432; Mindrinos et al. (1994) Cell 78:1089)).

In further embodiments, the first seed group may contain a herbicide resistance gene that provides herbicide tolerance, for example, to glyphosate-N-(phosphonomethyl)glycine (including the isopropylamine salt form of such herbicide). Exemplary herbicide resistance genes include glyphosate N-acetyltransferase (GAT) and 5-enolpyruvylshikimate-3-phosphate synthase (EPSPS), including those disclosed in US Pat. Publication No. U.S. 20040082770, as well as WO02/36782 and WO03/092360. Herbicide resistance genes generally code for a modified target protein insensitive to the herbicide or for an enzyme that degrades or detoxifies the herbicide in the plant before it can act. See, e.g., DeBlock et al. (1987) EMBO J. 6:2513; DeBlock et al. (1989) Plant Physiol. 91:691; Fromm et al (1990) BioTechnology 8:833; Gordon-Kamm et al. (1990) Plant Cell 2:603; and Frisch et al. (1995) Plant Mol. Biol. 27:405-9. For example, resistance to glyphosate or sulfonylurea herbicides has been obtained using genes coding for the mutant target enzymes, EPSPS and acetolactate synthase (ALS). Resistance to glufosinate ammonium, bromoxynil, and 2,4-dichlorophenoxyacetate (2,4-D) have been obtained by using bacterial genes encoding phosphinothricin acetyltransferase, a nitrilase, or a 2,4-dichlorophenoxyacetate monooxygenase, which detoxify the respective herbicides. Also contemplated are inhibitors of glutamine synthase such as phosphinothricin or basta (e.g., bar gene).

Other plants of the embodiments may contain stacks comprising traits desirable for processing or process products such as modified oils (e.g., fatty acid desaturase genes (U.S. Pat. Nos. 5,952,544; 6,372,965)); modified starches (e.g., ADPG pyrophosphorylases (AGPase), starch synthases (SS), starch branching enzymes (SBE), and starch debranching enzymes (SDBE)); and polymers or bioplastics (e.g., U.S. Pat. No. 5,602,321; beta-ketothiolase, polyhydroxybutyrate synthase, and acetoacetyl-CoA reductase (Schubert et al. (1988) J. Bacteriol. 170:5837-5847)). One could also combine the polynucleotides of the embodiments with polynucleotides providing agronomic traits such as male sterility (see, e.g., U.S. Pat. No. 5,583,210), stalk strength, flowering time, or transformation technology traits such as cell cycle regulation or gene targeting (e.g., WO 99/61619; U.S. Pat. Nos. 6,518, 487 and 6,187,994).

These stacked combinations can be created by any method including, but not limited to, cross-breeding plants by any conventional or TopCross methodology, or genetic transformation. If the sequences are stacked by genetically transforming the plants, the polynucleotide sequences of interest can be combined at any time and in any order. For example, a transgenic plant comprising one or more desired traits can be used as the target to introduce further traits by subsequent transformation. The traits can be introduced simultaneously in a co-transformation protocol with the polynucleotides of interest provided by any combination of transformation cassettes. For example, if two sequences will be introduced, the two sequences can be contained in separate transformation cassettes (trans) or contained on the same transformation cassette (cis). Expression of the sequences can be driven by the same promoter or by different promoters. In certain cases, it may be desirable to introduce a transformation cassette that will suppress the expression of the polynucleotide of interest. This may be combined with any combination of other suppression cassettes or overexpression cassettes to generate the desired combination of traits in the plant. It is further recognized that polynucleotide sequences can be stacked at a desired genomic location using a site-specific recombination system. See, e.g., WO 99/25821, WO 99/25854, WO 99/25840, WO 99/25855, and WO 99/25853.

### Embodiments for Precision Blending and Separating

As mentioned above, creating or enhancing insect resistance in plants, for example by using transgenic seeds encoded with Bt toxins, may, over time, lead to resistance in the targeted pests to the toxins, for example through evolutionary processes. To slow the evolution of such pests, the Environmental Protection Agency's (EPA's) federal regulations require that farmers provide refuge plots, which in effect provide an area where pests will not be immediately killed.

To illustrate, in the high dose framework, the purpose of the refuge is to ensure that there are enough susceptible target pests to allow for a high probability of random mating between a susceptible insect and a putatively resistant insect. Because resistance to the Bt toxin is assumed to be rare and a recessive trait, the resulting progeny from the mating of a susceptible insect and a resistant insect would be heterozygous for resistance and would be killed by subsequent exposure to the Bt toxin. Thus, the predicted durability of the Bt toxin is extended because resistance alleles are actually removed from the pest population by subsequent exposure to the high dose Bt toxin.

In a non-high dose framework, resistance alleles are not removed from the population as heterozygous pests may not necessarily be killed by a non-high dose exposure to the Bt toxin. Thus, in this context, the refuge simply ensures that there are susceptible pests available for random mating to dilute the resistance genes in the pest population.

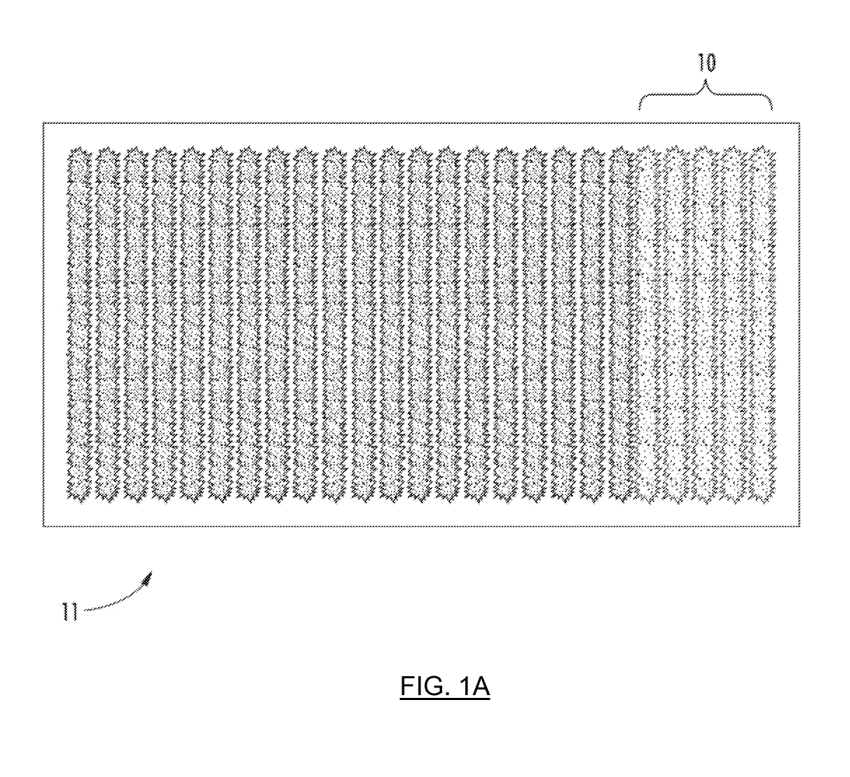

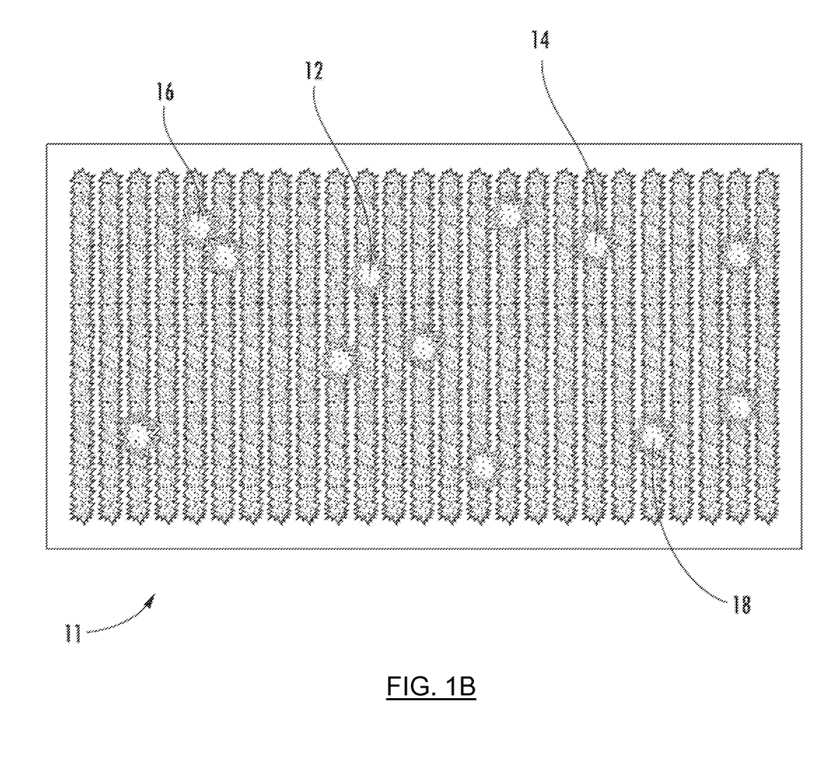

Rather than dedicating an area 10 of a field 11 to serve as a structured refuge (as shown in FIG. 1A), farmers may wish to intersperse refuge plants with transgenic plants. In other words, as illustrated in FIG. 1B, a certain percentage of refuge plants, such as plants 12, 14, 16, 18 that are non-transgenic or transgenic herbicide tolerant plants (e.g., not carriers of a Bt trait), may be scattered amongst and, thus, integrated with the transgenic pest-resistant plants in the plot, providing zones of refuge within the field 11. For example, approximately 10% of the plants in a given area may be refuge plants, whereas the remaining approximately 90% of the plants can be non-refuge plants; however, the refuge 10% need not be in the same area of the field, but can be scattered throughout the field, as shown in FIG. 1B. While 10% refuge plants is used in this example, one skilled in the art in light of this disclosure would recognize that the percentage of refuge plants may vary depending on the needed ratios for different applications or situations. For example, the percentage of refuge plants may be as high as 50%, and in particular may range from approximately 20% to approximately 5% in some cases.

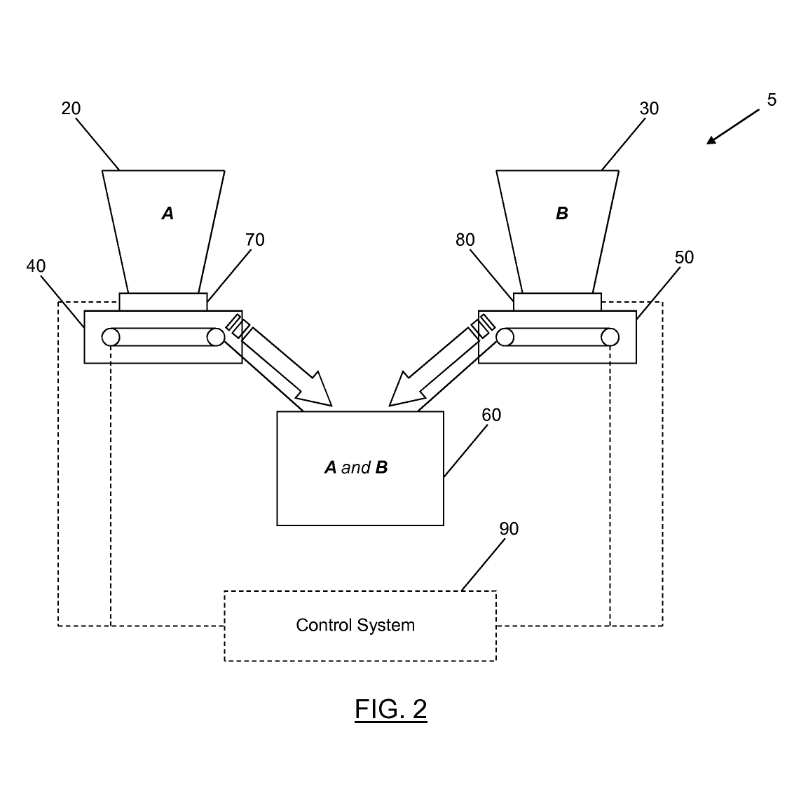

Considering the flexibility farmers may have with respect to where the refuge plants may be located, embodiments of the present invention provide a method of creating a precision blended seed product that includes seed for both refuge and non-refuge plants. As described in greater detail below, this can be done by combining a controlled portion of seed from a first seed group with a controlled portion of seed from a second seed group. Referring to FIG. 2, a system 5 is provided that includes a first seed hopper 20 configured to receive the first seed group A, and a second seed hopper 30 configured to receive the second seed group B. The first seed group A may be transferred to a first automated metering device 40, and the second seed group B may be transferred to a second automated metering device 50. The first and second metering devices 40, 50 may thus be configured to meter a controlled portion of seed from the first and second seed groups A, B, respectively, as will be described in greater detail below. The respective metered portion may then be combined together, such as in a third seed hopper 60, and later packaged to create a precision blended seed product that includes a predetermined portion of the first seed group A and a predetermined portion of the second seed group B.

In some embodiments, for example, a slide gate 70, 80 is provided between each of the first and second hoppers 20, 30 and the respective metering devices 40, 50 to slow down and control the transfer of seeds from the first and second hoppers. Each slide gate 70, 80 may be, for example, a roller slide gate (such as a roller slide gate available from Abel Manufacturing Co., Inc. of Appleton, Wisc.) that is actuated by an air or hydraulic cylinder. The slide gates 70, 80 may further be equipped with positional sensors and electric solenoid valves and/or switches such that the position of the slide gate may be controlled via a control system 90 to allow more or less seed to be transferred to the respective metering devices 40, 50.

As depicted in FIG. 2, each of the first and second metering devices 40, 50 may be a precision weigh belt feeder that is configured to feed a predetermined controlled portion of the seed from the respective hopper to the third seed hopper 60. Alternatively, a vibratory feeder and/or a gravity feeder (not shown) may be used to meter a controlled portion of seed from the first and second seed groups A, B.

Using the example of a precision weigh belt feeder, a Smart Weigh Belt Feeder available from K-Tron Process Group of Pitman, NJ, may be used to meter the respective controlled portion of seed. In this regard, the precision weigh belt may be configured to calculate the flow rate of seed based on the bulk density, the maximum allowable height of the bulk solid on the belt, and the belt speed. The belt speed on the weigh belt feeders may be variable, in some cases, such that control software of the control system 90 in communication with the slide gates 70, 80 and/or the weigh belt feeders 40, 50 may, for example, independently adjust the belt speed for each of the weigh belt feeders to compensate for having more or less seed on the respective weigh belt.

As an example, when the first hopper 20 is full of seed of the first seed group A, as the slide gate 70 begins to open, a large amount of seed may be transferred from the first hopper 20 to the first weigh belt 40 due to gravity. The control system 90 may receive feedback from the various components and adjust the system parameters accordingly. For example, information regarding the position of the slide gate 70 may cause the control system 90 to direct the slide gate not to open further. In addition, the speed of the first weigh belt 40 may be increased to avoid piling of seed from the first seed group A on the belt and, rather, promote spreading of the seed along the belt for more even and consistent combining. Furthermore, the speed of the second weigh belt 50 may also by increased to allow for more of the second seed group B to be combined with the portion of seed group A to maintain the predetermined ratio in the precision blended seed product. If not enough of the second seed group B is being combined with the metered portion of seed group A, the control system 90 may direct the second slide gate 80 to open more fully, thereby transferring more seed of the second seed group B onto the respective weigh belt feeder 50.

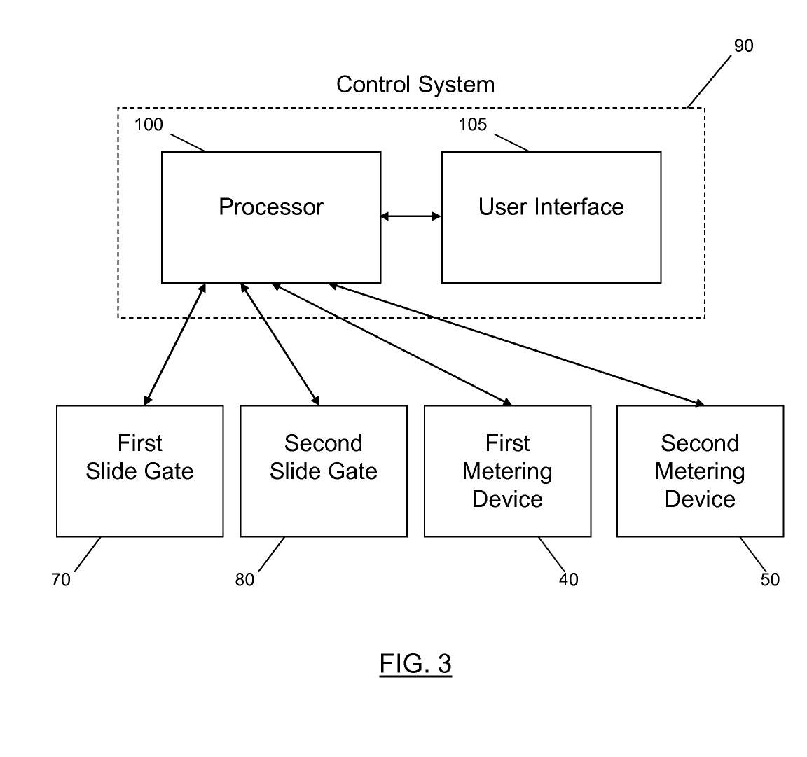

Referring to FIG. 3, the control system 90 may include various components for communicating with and directing the operation of the precision blending system 5. For example, the control system 90 may include a processor 100 and a user interface 105, where the processor is configured to receive user inputs entered via the user interface that dictate system parameters. The processor 100 may cause images to be generated on, for example, a display monitor (not shown) that displays the user interface 105, and an authorized user may thus be prompted to enter certain information (e.g., via a mouse, keyboard, touch screen, or other user input device, not shown) that can then be used by the processor to direct operation of, for example, the slide gates 70, 80 and/or the metering devices 40, 50.

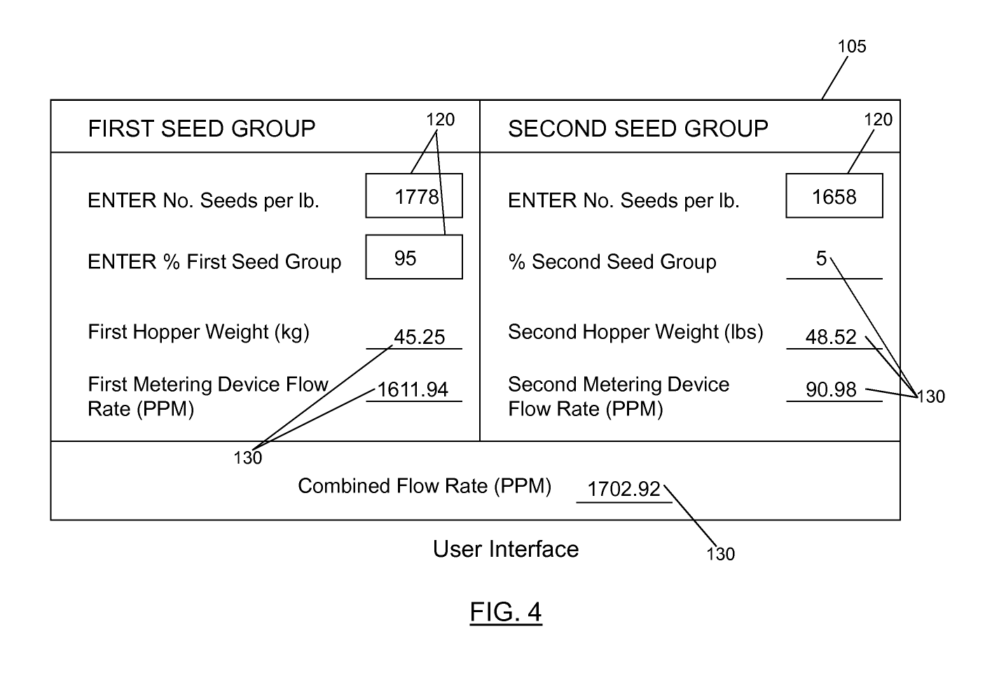

For example, as depicted in FIG. 4, the processor 100 may cause text prompts 110 to be generated on the user interface 105 that request input from the user regarding the number of seeds per pound for the first seed group A and for the second seed group B. The user may, for example enter a value of 1778 seeds per pound for the first seed group A and 1658 seeds per pound for the second seed group B in the respective input fields 120.

The number of seeds per pound may vary depending on the type of seed (i.e., the type of crop), the size, shape, and/or quality of the seeds, the intended use, and other factors and may be determined prior to the receipt of the seed by the respective first or second hopper 20, 30. In some cases, seeds are processed and grouped prior to the precision blending process based on seed size and shape. For example, in the case of corn, automated equipment (such as flat screens and other optical instruments) may be used to separate round corn kernels from flat corn kernels. In addition, round kernels and flat kernels each may be further processed to group similarly-sized kernels together (e.g., small kernels vs. large kernels). Such groupings may be made for quality purposes (e.g., to group together seeds that have similar trait purity and germination characteristics), to facilitate further processing with respect to removal of diseased or damaged seed), or to enhance plantability by allowing farmers to select seed that can be handled by the farmers' equipment.

Referring again to FIG. 4, in addition to the number of seeds per pound, the user may further be prompted to enter the percentage of the first seed group A that is desired in the precision blended seed product, and the user may enter, for example, a value of 95% in the respective input field 120. Based on the received user inputs 120, the processor 100 may calculate certain system parameters 130, such as the percentage of the second seed group B in the precision blend; the hopper weights for the first and second hoppers 20, 30; the flow rates for the first and second metering devices 40, 50; and the combined flow rate into the third seed hopper 60. The calculated system parameters 130 may be presented to the user via the user interface 105 to allow the user to verify and monitor the operation of the system 5.

Turning again to FIG. 3, the processor 100 may use the calculated system parameters 130 to direct operation of the system components, such as the slide gates 70, 80 and the metering devices 40, 50. The processor 100 may also receive feedback from the system components, such as information regarding the position of the slide gates 70, 80 and/or the actual weight of seed on the respective metering devices 40, 50, and may use this information to adjust the system parameters and direct the components accordingly to maintain the resulting precision blend within a set range of variance.

In this regard, various components of the system 5 may be associated with certain variations in output. For example, with reference to FIG. 2, in embodiments in which a weigh belt feeder is used for the metering devices 40, 50, each weigh belt feeder may be configured to output product within ±0.5% of the desired seed portion (e.g., 95% first seed group A ±0.5%. In addition, as noted above, the precision blend may be combined in a third seed hopper 60 and, from there, may be transferred into individual packages, for example to be marked for sale. Although the metering of a controlled portion of seed from the first seed group A and from the second seed group B into the third seed hopper 60 may inherently result in a blending of the seeds from the two seed groups within the third seed hopper, the blending effect may also be associated with a variation from the nominal desired percentage, such as ±1%, or better. Thus, a user desiring a precision blended seed product that includes 95% of the first seed group A and 5% of the second seed group B (i.e., 95% A/5% B) may be guaranteed a precision blended seed product that is 95% A/5% B±1% (i.e., between 94% A/6% B and 96% A/4% B). It should be noted that in certain instances a hard threshold may exist for one or more of the seed components (e.g., a requirement that the seed blend contain no less than 10% of seed group B). In such cases, the blending process would be set up to compensate for these variations, such that in the worst case scenario of variation, the resultant blend would still meet the requirements.

The system 5 described above in connection with FIGS. 2-4 may be implemented on any scale. For example, individual consumers of seed product may implement the system 5 to produce precision blended seed product for use in a single field. In contrast, the system 5 may be implemented on a large scale, such as when the system is part of a seed production and packaging facility that supplies precision blended seed product to a number of farmers. In the case of a large scale facility, individual components may be replaced with larger versions of the same components. For example, the first and second seed hoppers 20, 30 may be replaced with first and second seed bins configured to hold more seed than the hoppers. These seed bins may be fed by various seed conveying systems. Also, multiple stations may be set up to work in tandem to produce a greater volume of precision blended seed product, and the system 5 may be configured to work in connection with large-scale packaging and distribution systems, as will be recognized by those skilled in the art in light of this disclosure.

In some embodiments, the first seed group A comprises seed of a transgenic pest-resistant crop and the second seed group B comprises seed of a non-transgenic crop or a transgenic herbicide tolerant crop. Thus, in such cases, the non-transgenic crop or transgenic herbicide tolerant crop serves as the refuge. In other embodiments, the first seed group A comprises seed of a first transgenic pest-resistant crop and the second seed group B comprises seed of a second transgenic pest-resistant crop. For example, the first seed group A in this case may include a pesticidal agent with a particular active ingredient (such as, for example, a Bt protein), as described above, whereas the second seed group B may include a pesticidal agent with a different active ingredient or may not include a pesticidal agent (e.g., may include an herbicide tolerant trait). Thus, the second seed group B in this case would serve as a refuge with respect to the first seed group A while still providing the respective plants with a degree of resistance to pests. In other embodiments, both the first seed group A and the second seed group B comprise seed of a non-transgenic crop. In some embodiments, the predetermined portions of the precision blended seed product comprise approximately 95% seed from the first seed group A and approximately 5% seed from the second seed group B, whereas in other embodiments the blended seed product may comprise approximately 90% or approximately 80% seed from the first seed group A and approximately 10% or approximately 20% seed from the second seed group B, respectively. One skilled in the art will recognize that in still other embodiments various other ratio combinations may be used. For example, in some embodiments the blended seed product may comprise from approximately 1% up to approximately 50% seed from one seed group and a complementary amount of seed from the other seed group.

The seed from the first and second seed groups A, B may be any type of seed, such as corn seed, cotton seed, sunflower seed, grass seed, millet seed, vegetable seed, flower seed, soybean seed, alfalfa seed, wheat seed, sorghum seed, canola seed, or rice seed. In other embodiments, however, the seed groups may include seeds from trees (e.g., deciduous or coniferous), such as for creating seeding blends of defined tree combinations for use in reforestation projects.

As noted above, a resistance trait can be introduced into the crop plant by transformation (i.e., transgenic) or traditional breeding methods. Alternatively, an external pesticidal agent, such as a seed treatment or chemical pesticide may be used as one or both of the sources of pest resistance. Thus, pest resistance may be conferred via treatment of plant propagation material. Before plant propagation material (e.g., fruit, tuber, bulb, corn, grains, and/or seed) is sold as a commercial product, it is customarily treated with a protectant coating comprising herbicides, insecticides, fungicides, bactericides, nematicides, molluscicides, or mixtures of several of these preparations, if desired, together with further carriers, surfactants, or application-promoting adjuvants customarily employed in the art of formulation to provide protection against damage caused by bacterial, fungal, or animal pests. In order to treat the seed, the protectant coating may be applied to the seeds either by impregnating the tubers or grains with a liquid formulation or by coating them with a combined wet or dry formulation. In addition, in special cases, other methods of application to plants are possible, e.g., treatment directed at the buds or the fruit.

Further, native resistance genes can also be used in the present invention, such as maysin (Waiss, et al., J. Econ. Entomol. 72:256-258 (1979)); maize cysteine proteases, such as MIR1-CP (Pechan, T. et al., Plant Cell 12:1031-40 (2000)); DIMBOA (Klun, J. A. et al., J. Econ. Entomol. 60:1529-1533 (1967)); and genes for husk tightness (Rector, B. G. et al., J. Econ. Entomol. 95:1303-1307 (2002)). Such genes may be used in the context of the plants in which they are found or inserted into other plants via transgenic means as is known in the art and/or discussed herein.

Accordingly, in some embodiments, the first seed group A comprises seed treated with a first seed treatment and the second seed group B comprises seed treated with a second seed treatment, such as a pesticidal or insecticidal agent. A “pesticidal agent” is a pesticide that is supplied externally to the crop plant, or a seed of the crop plant. The term “insecticidal agent” has the same meaning as pesticidal agent, except that its use is intended for those instances wherein the pest is an insect. Pesticides suitable for use in the invention include neonicintinoids, pyrethrins and synthetic pyrethroids; oxadiazine derivatives (see, e.g., U.S. Pat. No. 5,852,012); chloronicotinyls (see, e.g., U.S. Pat. No. 5,952,358); nitroguanidine derivatives (see, e.g., U.S. Pat. Nos. 5,633,375; 5,034,404; and 5,245,040); triazoles; organophosphates; pyrrols, pyrazoles and phenyl pyrazoles (see, e.g., U.S. Pat. No. 5,952,358); diacylhydrazines; carbamates; sulfoximines such as e.g., sulfoxaflor [N-[methyloxido[1-[6-(trifluoromethyl)-3-pyridinyl]ethyl]-λ(4)-sulfanylidene]cyanamide] (U.S. 20050228027) and biological/fermentation products. Known pesticides within these categories are listed in, for example, The Pesticide Manual, 11th ed., (1997) ed. C. D. S. Tomlin (British Crop Protection Council, Farnham, Surrey, UK). When an insecticide is described herein, it is to be understood that the description is intended to include salt forms of the insecticide as well as any isomeric and/or tautomeric form of the insecticide that exhibits the same insecticidal activity as the form of the insecticide that is described. The insecticides that are useful in the present method can be of any grade or purity that passes in the trade as such insecticide. In still other embodiments, the first and/or second seed group A, B is optionally treated with acaricides, nematicides, fungicides, bactericides, herbicides, insecticides, growth regulators, colorants, amendments, micronutrients, inoculants, carriers, coatings, polyments, and combinations thereof.

In still other embodiments, the first seed group A may comprise seed of a transgenic male-sterile parent crop and the second seed group B may comprise seed of a transgenic pollinator crop. In this regard, the male-sterile parent crop is a plant that produces no pollen, whereas the pollinator crop may be genetically configured to elicit specialized traits in plants resulting from pollination by the pollinator crop. For example, in corn, a pollinator crop may be configured to produce plants resulting from pollination with the pollinator crop that have kernels with a much larger than average germ or embryo so as to enhance the oil and protein quality of the offspring crop. These traits may be desirable, for example, when producing corn for livestock feed because such grain has greater energy than normal corn. In some embodiments, the predetermined portions of the precision blended seed product comprise between approximately 80% and approximately 95% seed from the first seed group A and between approximately 20% and approximately 5% seed from the second seed group B, such as approximately 91% seed from the first seed group A and approximately 9% seed from the second seed group B.

By providing farmers with a precision blended seed product that includes a predetermined portion of the first seed group A and a predetermined portion of the second seed group B, as described above, there should no longer be a necessity for a structured refuge in a field.

In order to have as many plants resistant to pests as possible while still managing the pests' resistance to the pesticidal effects, plants in the field may be provided with more than one mechanism of pest resistance for at least one pest. For example, if it is desired to reduce or eliminate the necessity of a structured refuge for ECB, plants in the plot may be provided with at least two forms of pest resistance for ECB with different modes of action. In this regard, the possibility for development of resistant ECB pests is dramatically reduced, as the likelihood that a particular pest will have a necessary random mutation providing for resistance to both modes of pesticidal action would be remote. At the same time, the farmer's yield is maximized because the refuge crop is also, in this case, resistant to the pests. Non-limiting examples of combinations of sources of pest resistance that can be used in the context of the present invention have been described previously with regard to both ECB and other pests, and could include transgenes producing different Bt proteins (or other proteins providing such resistance), chemical pesticides, seed treatments, or a combination thereof. Particular pairs of Bt proteins with different modes of action have been described above.

As a result, the farmer no longer has to sacrifice yield in a portion of a planting in order to prevent insect resistance from developing. In addition, providing precision blended seed product also prevents the compliance issues discussed previously, where a farmer may, in the interest of increasing yield or simply through imperfect planting procedures, plant an insufficient refuge for managing the development of resistant pests. Furthermore, the availability of the blended products provides farmers with the ability to enhance both their productivity and their on-farm management practices.

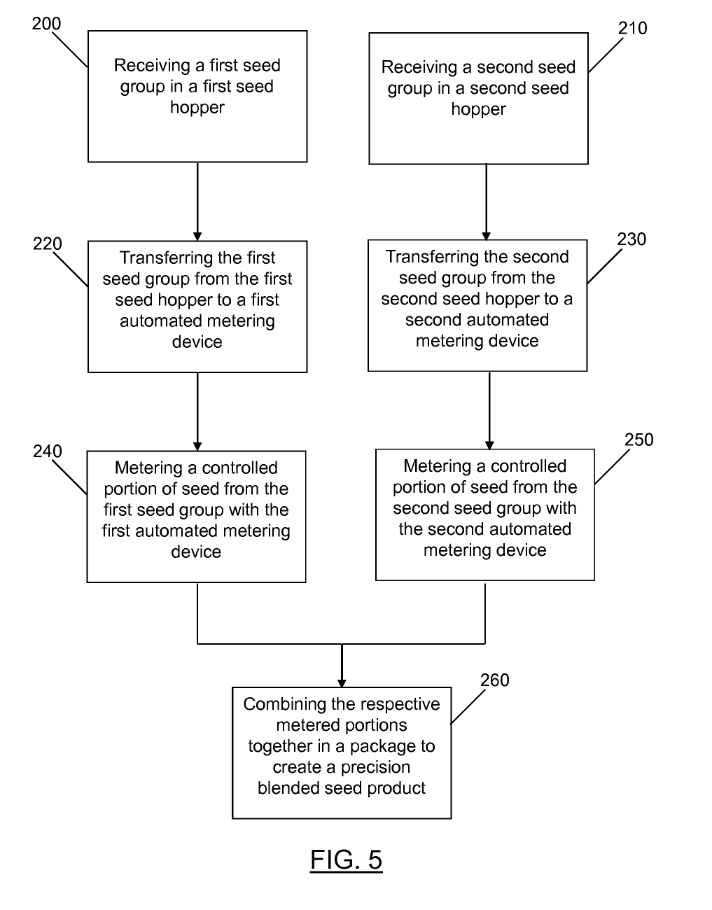

Embodiments of a method of creating a precision blended seed product are summarized in FIG. 5. With reference to FIG. 5, a first seed group is received in a first seed hopper at step 200, and a second seed group is received in a second seed hopper at step 210. The first seed group is then transferred from the first seed hopper to a first automated metering device at step 220, and the second seed group is transferred from the second seed hopper to a second automated metering device at step 230. At step 240, a controlled portion of seed from the first seed group is metered with the first automated metering device, and at step 250 a controlled portion of seed from the second seed group is metered with the second automated metering device. The respective metered portions are then combined together in a package to create a precision blended seed product at step 260, as described above. As shown in FIG. 5, steps 200, 220, and 240 may occur in parallel with steps 210, 230, and 250 (e.g., the receipt and handling of the first seed group may occur at substantially the same time as the receipt and handling of the second seed group), or the various steps may occur sequentially in series.

Often, in preparing a precision blended seed product for sale and distribution to farmers, not all of the seed product is sold or consumed, and some of the precision blended seed product is carried over to the next planting cycle. In such cases, it may be important to confirm that both components of the seed product (i.e., the first seed group A and the second seed group B) are still viable and meet the quality standards of the manufacturer and/or distributor. Thus, it may be necessary to separate a sample portion of the seed using an automated seed separating device into a portion of seed that substantially consists of seed from the first seed group A and a portion of seed that substantially consists of seed from the second seed group B.

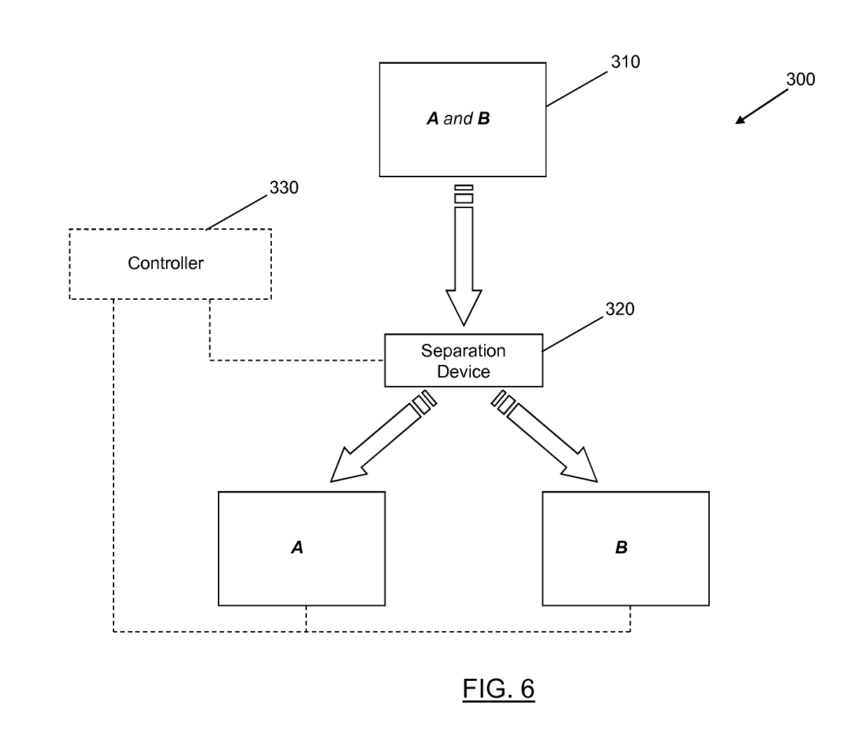

Turning to FIG. 6, a system 300 is provided for separating two or more seed groups from a blended seed product. Blended seed product 310, such as a seed product that includes a blend of seed from a first seed group A and seed from a second seed group B may be received at an automated seed separating device 320. The blended seed product may then be separated using the automated seed separating device into a portion of seed that substantially consists of seed from the first seed group A and a portion of seed that substantially consists of seed from the second seed group B. In this way, a representative portion of each seed group A, B may be tested (e.g., by analyzing a sample of each for germination) to determine whether the respective seed meets predetermined standards of quality for sale to farmers.

The automated seed separating device 320 may be any device configured to separate seed based on a seed characteristic, such as seed size, seed color, seed treatment color, and/or seed weight, among other characteristics. For instance, considering the example described above of a precision blended seed product including 90% transgenic seed and 10% non-transgenic seed, an exterior coating of color may have been applied to the seed of each constituent seed group to visually distinguish the transgenic seed from the non-transgenic seed. For example, the transgenic seed may have a blue color applied, whereas the non-transgenic seed may have a red color applied. In this case, the automated seed separating device 320 may be an automated precision color seed sorter, such as a SCANMASTER™ II Series color sorter available from Satake USA Incorporated of Stafford, Tex. The automated seed separating device 320 may, for example, include high resolution cameras and/or infrared detectors configured to identify differently colored seeds and may further include ejectors (such as compressed air ejectors) to target and separate out seeds from one of seed groups (e.g., the non-transgenic seed) based on the identified color.

Other potential mechanisms for separation include differential density centrifugation, floatation or gravity-based separation, magnetic separation (for example using laser-assisted seed selection), and sieves to sort by size and shape. Seed coatings may be used, for example, to create up-front differences in seed size, shape, or density to facilitate seed separation. Such coatings may be selected so as not to have any significant impact on the appearance, general handling, germination, and/or viability of the seed from the grower's perspective.

As noted above with respect to the system 5 for producing a precision blended seed product, the system 300 described above and depicted in FIG. 6 may be implemented on a small or large scale. Accordingly, individual users may implement the system 300 to separate a small amount of seed product (such as on the order of 5 to 10 bags of seed product). At the same time, the system 300 may be implemented as part of a seed production and packaging facility that supplies precision blended seed product to separate out, test, and re-package carryover seed for distribution and sale on a large scale to a number of farmers.

Given the broad variation in the size and shape of seeds of different crops, the system may be designed to specifically handle seed of one unique crop (e.g., corn seed, cotton seed, sunflower seed, grass seed, millet seed, vegetable seed, flower seed, soybean seed, alfalfa seed, wheat seed, sorghum seed, canola seed, or rice seed). Alternatively, the system may be designed to be adaptable to a specific crop seed type, where certain components of the system (such as a hopper, controller system, user interface, etc.) would be suitable for use with any crop, while other interchangeable components would be configured within the system for the particular seed type that is being blended into a product.

As is the case with creating a precision blended seed product, the seed from the first and second seed groups A, B may be corn seed, cotton seed, sunflower seed, grass seed, millet seed, vegetable seed, flower seed, soybean seed, alfalfa seed, wheat seed, sorghum seed, canola seed, or rice seed. Furthermore, the first seed group A may comprise seed of a transgenic pest-resistant crop, whereas the second seed group B may comprise seed of a non-transgenic crop or a transgenic herbicide tolerant crop. Alternatively, the first seed group A may comprise seed of a first transgenic pest-resistant crop, whereas the second seed group B may comprise seed of a second transgenic pest-resistant crop. In some situations, both the first and second seed groups A, B may be non-transgenic. In addition, the first seed group A may comprise a portion of seed treated with a first seed treatment and the second seed group B may comprise a portion of seed treated with a second seed treatment, or the first seed group may comprise seed of a transgenic male-sterile parent crop while the second seed group may comprise seed of a transgenic pollinator crop, as described above. Thus, any combination of seeds may be separated, provided that each seed group A, B has a characteristic that distinguishes the seed group from the other seed group.

In some embodiments, the system 300 further includes a controller 330 that is configured to determine a relative ratio of the first and second seed groups in the blended seed product based on the separation of the two seed groups from each other by the separating device 320. The controller 330, which may include a processor similar to that discussed in connection with the control system 90 depicted in FIG. 3, may monitor, for example, the number of seeds identified as belonging to the second seed group B and the number of total seeds A, B passing through the system and calculate the relative ratio of the two components. In some cases, the controller 330 may be integral to the automated seed separating device 320. In other cases, however, the controller 330 may be separate from the automated seed separating device 320, such as in the case of a stand-alone controller, and may monitor the relative weights of the separated seed from the first seed group A and the separated seed from the second seed group B. The controller 330 may thus be able to determine the relative ratio of the first and second seed groups in the blended seed product, for example, based on the number of seeds per pound of each seed group.

As mentioned above, the viability of a representative sample of the separated seed from the first seed group A and/or the separated seed from the second seed group B may be tested to determine whether the respective seed can be sold to farmers. In the event that, upon testing, one of the seed groups does not meet predetermined standards for viability or is otherwise unsuitable for sale, but the other of the seed groups is suitable for planting, it may be cost effective to discard the unsuitable portion and replace it with new seed to create a precision blended seed product that includes a predetermined portion of the first seed group and a predetermined portion of the second seed group (rather than discard all of the seed).

Thus, more than just a portion of the blended seed product may need to be separated into its component seed groups to create the new precision blended seed product.

For example, if a representative portion of the second seed group B that makes up (in this example) 10% of the blended seed product is found unsuitable, the entire batch of blended seed product corresponding to the tested representative portion may be separated using the automated seed separating device into a portion of seed that substantially consists of seed from the first seed group A and a portion of seed that substantially consists of seed from the second seed group B (i.e., via large-scale separation). The portion of separated seed that substantially consists of seed from the second seed group B, which in this case did not meet quality standards, may be discarded based on the testing, and a metered portion of separated seed from the first seed group A, which was not discarded based on the testing results, may be combined with a metered portion of new seed of the second seed group B to create a precision blended seed product that includes a predetermined portion of the first seed group A and a predetermined portion of the second seed group B, as described above and depicted in the figures. In the case of a 90-10% precision blended seed product, this saves 90% of the seed that may have otherwise been discarded based on poor quality results for only 10% of the seeds.

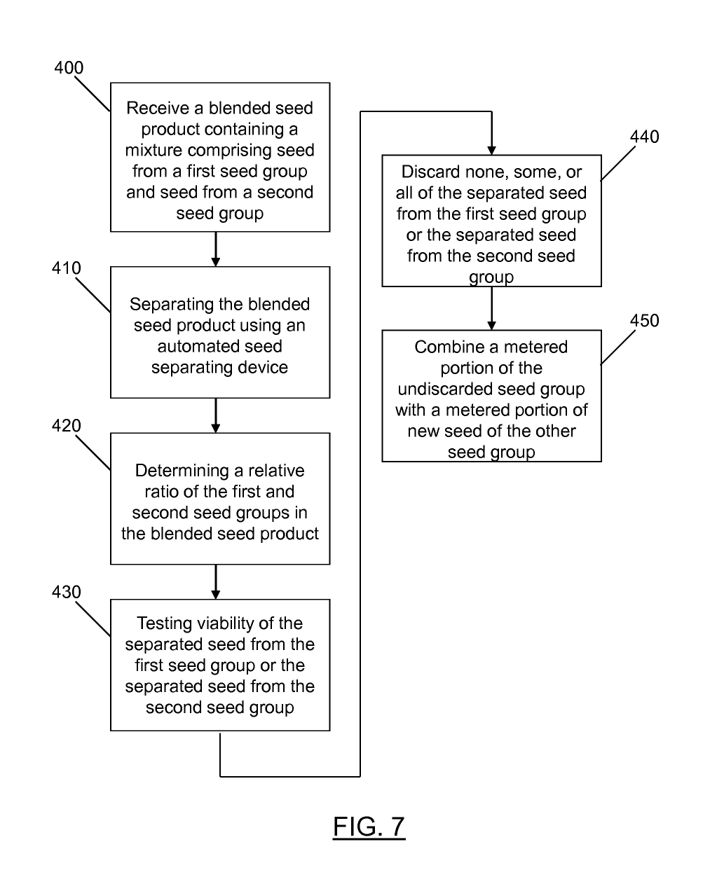

Embodiments of a method of separating two or more seed groups from a blended seed product are summarized in FIG. 7. With reference to FIG. 7, a blended seed product containing a blend comprising seed from a first seed group and seed from a second seed group may be received at step 400. The blended seed product may then be separated using an automated seed separating device at step 410. In some cases, a relative ratio of the first and second seed groups in the blended seed product may be determined, such as by using a controller, at step 420. Furthermore, in some embodiments, the viability of the separated seed from the first seed group and/or the separated seed from the second seed group may be tested at step 430. Based on the results of the testing step 430, one of the separated seed from the first seed group or the separated seed from the second seed group may be discarded at step 440. In some cases, based on the seed viability determinations, it may be necessary to discard some, all, or none of the separated seed. Accordingly, at step 450, a metered portion of the undiscarded one of the separated seed from the first seed group or the separated seed from the second seed group may be combined with a metered portion of new seed of the other of the first seed group or the second seed group to create a precision blended seed product that includes a predetermined portion of the first seed group and a predetermined portion of the second seed group.

While embodiments of the invention are described predominantly using examples of pests affecting corn, the embodiments herein may also be applied to fields where resistance management is needed in the context of other crops and other pests. For example, as noted above, seed from the first and second seed groups A, B may be selected from the group consisting of soybeans, wheat, barley, sorghum, cotton, sunflower, grass, millet, vegetable, flower, alfalfa, canola, rice, and the like. Embodiments of the invention may also be used to produce precision blends of seed product exhibiting traits other than pesticidal action, such as seeds that have been configured to include traits for disease tolerance, herbicide tolerance, and/or various agronomic or grain quality traits. For example, a seed blend may be designed to achieve a certain level of extractable seed protein and/or oil in the final blended product, such as by using high protein in one of the seed groups and high oil in the other to give a desired combination upon extraction. In addition, in some embodiments, seed blends may be separated based on such traits, as well as based on different grain density or opacity. In addition, embodiments of the invention may blend more than two seed groups together to create a precision blended seed product and/or separate more than two seed groups from a blended seed product. It is further noted that, in some cases, the seeds of the first and second seed groups A, B may be the same seeds (e.g., same crop and/or same size and/or same genetic traits, but for example, having different seed treatments applied thereto), whereas in other cases the seeds of one seed group may be genetically and/or physically different from seeds of the other seed group.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of creating a precision blended seed product, said method comprising:
receiving a first seed group in a first seed hopper;
receiving a second seed group in a second seed hopper;
transferring the first seed group from the first seed hopper to a first automated metering device;
transferring the second seed group from the second seed hopper to a second automated metering device;
metering a controlled portion of seed from the first seed group with the first automated metering device;
metering a controlled portion of seed from the second seed group with the second automated metering device; and
combining the respective metered portions together in a package to create a precision blended seed product that includes a predetermined portion of the first seed group and a predetermined portion of the second seed group.

2. The method of claim 1, wherein the first seed group comprises seed of a transgenic pest-resistant crop and the second seed group comprises seed of a non-transgenic crop.

3. The method of claim 1, wherein the first seed group comprises seed of a transgenic pest-resistant crop and the second seed group comprises seed of a transgenic herbicide tolerant crop.

4. The method of claim 1, wherein the first seed group comprises seed of a non-transgenic crop and the second seed group comprises seed of a non-transgenic crop.

5. The method of claim 1, wherein the first seed group comprises seed of a first transgenic pest-resistant crop and the second seed group comprises seed of a second transgenic pest-resistant crop.

6. The method of claim 5, wherein the predetermined portions of the precision blended seed product comprise approximately 80% seed from the first seed group and approximately 20% seed from the second seed group.

7. The method of claim 5, wherein the predetermined portions of the precision blended seed product comprise approximately 90% seed from the first seed group and approximately 10% seed from the second seed group.

8. The method of claim 5, wherein the predetermined portions of the precision blended seed product comprise approximately 95% seed from the first seed group and approximately 5% seed from the second seed group.

9. The method of claim 1, wherein the predetermined portions of the precision blended seed product comprise approximately 80% seed from the first seed group and approximately 20% seed from the second seed group.

10. The method of claim 1, wherein the predetermined portions of the precision blended seed product comprise approximately 90% seed from the first seed group and approximately 10% seed from the second seed group.

11. The method of claim 1, wherein the predetermined portions of the precision blended seed product comprise approximately 95% seed from the first seed group and approximately 5% seed from the second seed group.

12. The method of claim 1, wherein the first seed group comprises seed treated with a first seed treatment and the second seed group comprises seed treated with a second seed treatment.

13. The method of claim 12, wherein the first and second seed treatments are selected from the group consisting of: insecticides; fungicides; nematicides; growth regulators; colorants; amendments; micronutrients; inoculants; carriers; coatings;
polymers; and combinations thereof.

14. The method of claim 1, wherein the first seed group comprises seed of a transgenic male-sterile parent crop and the second seed group comprises seed of a transgenic pollinator crop.

15. The method of claim 14, wherein the predetermined portions of the precision blended seed product comprise between approximately 80% and approximately 95% seed from the first seed group and between approximately 20% and approximately 5% seed from the second seed group.

16. The method of claim 15, wherein the predetermined portions of the precision blended seed product comprise approximately 91% seed from the first seed group and approximately 9% seed from the second seed group.

17. The method of claim 1, wherein the seed from the first and second seed groups is selected from the group consisting of: corn seed; cotton seed; sunflower seed; grass seed; millet seed; vegetable seed; flower seed; soybean seed; alfalfa seed; wheat seed; sorghum seed; canola seed; and rice seed.

18. The method of claim 1, wherein said step of metering a controlled portion of seed from the first seed group comprises metering a controlled portion of seed from the first seed group using a first precision weigh belt feeder, and wherein said step of metering a controlled portion of seed from the second seed group comprises metering a controlled portion of seed from the second seed group using a second precision weigh belt feeder.

19. The method of claim 1, wherein said step of metering a controlled portion of seed from the first seed group comprises metering a controlled portion of seed from the first seed group using at least one of a first vibratory feeder and a gravity feeder, and wherein said step of metering a controlled portion of seed from the second seed group comprises metering a controlled portion of seed from the second seed group using a second vibratory feeder and a weighing hopper.

20. The method of claim 19, wherein the controlled portion of seed from the first seed group and the controlled portion of seed from the second seed group are received together in a third seed hopper.

21. A method of separating two or more seed groups from a blended seed product, said method comprising:
receiving at an automated seed separating device a blended seed product containing a blend comprising seed from a first seed group and seed from a second seed group; and
separating the blended seed product using the automated seed separating device into a portion of seed that substantially consists of seed from the first seed group and a portion of seed that substantially consists of seed from the second seed group.

22. The method of claim 21, wherein the seed separating device is configured to separate seed based on a seed characteristic selected from the group consisting of: seed size, seed color, seed treatment color, seed density, seed shape, and seed weight.

23. The method of claim 21, wherein said step of separating the blended seed product comprises separating the blended seed product using an automated precision color seed sorter.

24. The method of claim 21, wherein the seed from the first and second seed groups is selected from the group consisting of: corn seed; cotton seed; sunflower seed; grass seed; millet seed; vegetable seed; flower seed; soybean seed; alfalfa seed;
wheat seed; sorghum seed; canola seed; and rice seed.

25. The method of claim 21, wherein the first seed group comprises seed of a transgenic pest-resistant crop and the second seed group comprises seed of a non-transgenic crop.

26. The method of claim 21, wherein the first seed group comprises seed of a transgenic pest-resistant crop and the second seed group comprises seed of a transgenic herbicide tolerant crop.

27. The method of claim 21, wherein the first seed group comprises seed of a non-transgenic crop and the second seed group comprises seed of a non-transgenic crop.

28. The method of claim 21, wherein the first seed group comprises seed of a first transgenic pest-resistant crop and the second seed group comprises seed of a second transgenic pest-resistant crop.

29. The method of claim 21, wherein the first seed group comprises a portion of seed treated with a first seed treatment and the second seed group comprises a portion of seed treated with a second seed treatment.

30. The method of claim 21, wherein the first seed group comprises seed of a transgenic male-sterile parent crop and the second seed group comprises seed of a transgenic pollinator crop.

31. The method of claim 21, further comprising determining a relative ratio of the first and second seed groups in the blended seed product based on said separating step.

32. The method of claim 21, further comprising testing viability of the separated seed from the first seed group or the separated seed from the second seed group.

33. The method of claim 32, further comprising discarding at least a portion of one of the separated seed from the first seed group or the separated seed from the second seed group based on said testing step.

34. The method of claim 33, further comprising combining a metered portion of the undiscarded one of the separated seed from the first seed group or the separated seed from the second seed group with a metered portion of new seed of the other of the first seed group or the second seed group to create a precision blended seed product that includes a predetermined portion of the first seed group and a predetermined portion of the second seed group.

35. The method of claim 1, wherein the predetermined portions of the precision blended seed product comprise approximately 80% seed from the first seed group and approximately 20% seed from the second seed group.

36. The method of claim 1, wherein the predetermined portions of the precision blended seed product comprise approximately 90% seed from the first seed group and approximately 10% seed from the second seed group.

37. The method of claim 1, wherein the predetermined portions of the precision blended seed product comprise approximately 95% seed from the first seed group and approximately 5% seed from the second seed group.

38. The method of claim 3, wherein the predetermined portions of the precision blended seed product comprise approximately 80% seed from the first seed group and approximately 20% seed from the second seed group.

39. The method of claim 3, wherein the predetermined portions of the precision blended seed product comprise approximately 90% seed from the first seed group and approximately 10% seed from the second seed group.

40. The method of claim 3, wherein the predetermined portions of the precision blended seed product comprise approximately 95% seed from the first seed group and approximately 5% seed from the second seed group.

41. The method of claim 4, wherein the predetermined portions of the precision blended seed product comprise approximately 80% seed from the first seed group and approximately 20% seed from the second seed group.

42. The method of claim 4, wherein the predetermined portions of the precision blended seed product comprise approximately 90% seed from the first seed group and approximately 10% seed from the second seed group.

43. The method of claim 4, wherein the predetermined portions of the precision blended seed product comprise approximately 95% seed from the first seed group and approximately 5% seed from the second seed group.
